(19) United States
(12) Patent Application Publication
(10) Pub. No.: US 2005/0104418 A1
(43) Pub. Date: May 19, 2005

(54) Modular roof for a motor vehicle and method for assembly thereof

(76) Inventor: Thomas Zirbs, Weil der Stadt (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/496,958

(22) PCT Filed: Oct. 4, 2002
(86) PCT No.: PCT/EP02/11148

(30) Foreign Application Priority Data
Nov. 28, 2001 (DE) 101 58 401.6

(51) Int. Cl. B62D 25/06

(52) U.S. Cl. 296/210

(57) ABSTRACT

To ensure a high quality appearance of vehicle bodies in the roof region, it is important for the convexity of a modular roof which is fitted into the vehicle body to be matched in the installed state with high precision to the convexity of the side struts of the body. In order to be able to ensure this high-precision matching—irrespective of the manufacturing tolerances of the modular roof and of the body—the modular roof is provided with a convexity which is too small—when measured against the fitted state—and is pressed in its front and rear end regions into the desired state of convexity during installation. This desired state of convexity is fixed in relation to the vehicle body by clamping elements.

### BACKGROUND AND SUMMARY OF THE INVENTION

The present invention relates to a modular roof for a motor vehicle as is disclosed, for example, in German publication DE 197 09 016 A1. Furthermore, the invention relates to a method for installing a modular roof of this type.

German publication DE 197 09 016 A1 discloses a modular roof which is inserted into a roof opening of the vehicle body during the assembly of the vehicle with the aid of a bonding process. For this purpose, the modular roof is provided on the edge side with an encircling flange which, in the assembled position, overlaps with a flange in the roof opening of the vehicle body and is connected thereto via bonding connections. Furthermore, the roof module has a convexity in the longitudinal direction of the vehicle, i.e. a convex curvature; accordingly, the side struts of the body frame that lie opposite the roof module and the associated flanges of the roof opening are also made convex in the longitudinal direction of the vehicle, i.e. are provided with a convex curvature.

In order to produce a high quality vehicle, the position and the shaping of the roof module, in the fitted position, have to be coordinated with high precision with the position and the shaping of the side struts. This requires the convexity of the modular roof, in the fitted position, to coincide with high precision with the convexity of the side struts and of the flanges of the roof opening. This is because if the convexity of the roof module is greater than that of the roof struts of the body frame, then the roof module arches in the central region of the side struts with a gap in relation to the side struts being formed. If, on the other hand, the convexity of the roof module is smaller than that of the roof opening, then the front and/or the rear end region of the roof module will gape in relation to the flanges of the roof opening. In both cases, an esthetically unsatisfactory appearance of the body arises, since the curvatures of the two adjacent body regions—side struts of the body frame and roof module—do not coincide. Furthermore, leakages in the bonding connection in the roof region may occur—depending on the size of the gap between the roof module and the flanges of the roof opening.

This high-precision correspondence of the curvatures which is of decisive importance for the tightness and the high quality appearance of the body can be achieved only with a great deal of complexity in terms of the method. This is because for large-scale production the convexity of the side struts and also that of the roof module are subject to fluctuations caused by production. In general, the procedure therefore has to be based on the fact that the curvature (convexity) of the side struts of the body frame differs from that of the roof module to be fitted into this body and the curvatures can only be matched by complicated refinishing work.

The invention is therefore based on the object of developing a modular roof of the generic type in such a manner that this modular roof, which is subject to manufacturing tolerances, can be matched while fitting it into the roof opening of the vehicle body with high precision to a curvature in the longitudinal direction of the vehicle, which curvature is predetermined by the convexity of the side struts and is, for its part, likewise subject to manufacturing tolerances. Furthermore, the invention is based on the object of providing a method for installing the modular roof, which method is capable of large-scale production and ensures that the convexities of the side struts and of the modular roof coincide with high precision.

This object is achieved according to the invention.

According to the invention, the convexity of the modular roof which is to be used is smaller in the longitudinal direction of the vehicle than the convexity of the flange of the roof opening in the longitudinal direction of the vehicle. Before being fitted into the roof opening of the vehicle body, the modular roof therefore has a smaller curvature than the desired curvature which it is intended to have after being fitted into the roof opening. Furthermore, fixing elements are provided and are used to enable the rear and front edge regions of the modular roof to be clamped in relation to the roof opening, as a result of which the curvature of the modular roof is matched with high precision to that of the flanges of the side struts.

To install the modular roof, according to the invention the modular roof is first of all provided with an adhesive bead and is then placed onto the flanges of the roof opening of a vehicle body. Owing to the smaller convexity of the modular roof—in comparison with the convexity of the flanges in the longitudinal direction of the vehicle—the rear and/or front end regions of the modular roof gape open in relation to the flanges of the vehicle body. Forces are now exerted on these rear and front end regions of the roof module, as a result of which these regions are pressed onto the opposite flanges of the roof opening. The modular roof is then fixed in this clamped state in relation to the vehicle body with the aid of the fixing elements.

The design according to the invention of the modular roof and the installation method according to the invention ensure that the modular roof can be fitted—irrespective of manufacturing inaccuracies—into the roof opening of the body in a precisely fitting manner in respect of its curvature. Through the positioning of the modular roof and the subsequent pressing down of the end-side regions a reproducible installation process is provided which ensures that the two curved profiles are precisely coordinated in terms of contour in the fitted state even if there are fluctuations in the curvature of the modular roof and/or of the side struts. Great reliability in the installation can therefore be ensured even if there are relatively great manufacturing tolerances.

The fixing elements which serve for fixing the front and rear end regions of the modular roof in relation to the roof opening are expediently designed as hooks on the modular roof which, in the fitted position of the modular roof, engage under the flange of the roof opening. These hooks are advantageously fastened pivotably to the roof module, so that they can be pivoted into the inner region of the roof module during the fitting of the roof, and collisions with the flanges are therefore avoided; if the modular roof has been fitted and clamped in the desired position, then the hooks are pivoted outward, so that they engage under the flanges of the roof opening and therefore ensure that the modular roof is fixed in the roof opening in the clamped state. As an alternative, hooks, screws or pins which protrude through openings in the roof opening in the fitted position of the modular roof can be used as fixing elements.

In order to prevent the adhesive from being squeezed out during the pressing down of the front and rear regions of the modular roof, spacers are provided in the region of the roof edges in the vicinity of the bonding regions and protrude in the direction of the flanges of the roof opening. In the assembled position, the end surfaces of these spacers rest on the flanges of the roof opening and ensure that there is a minimum spacing for the adhesive between the modular roof edge and the upper sides of the flanges.

The method according to the invention permits the dimensionally precise insertion of different roof variants in the course of the assembly of the vehicle. In particular, sliding roofs, glass roofs, lamella roofs etc. and also fixed roofs can be used as the modular roof. Whereas sliding and glass roofs inherently have a certain amount of stiffness, fixed roofs—in particular if they consist only of a single deep-drawn panel—are relatively unstable; if the modular roof is a fixed roof consisting of a metal panel, then it is recommended to inject a molding compound behind the metal panel in order to give the modular roof a higher degree of inherent stiffness and thereby to simplify the handling. The same applies to plastic fixed roofs of small wall thickness which are expediently likewise to have a molding compound injected behind them.

The invention is explained in greater detail below with reference to an exemplary embodiment illustrated in the drawings.

### BRIEF DESCRIPTION OF THE DRAWINGS

FIG. 1 shows a schematic perspective view of a body with a modular roof which is to be fitted into the body;

FIG. 2 shows three selected method steps during the installation of the roof module in a sectional view along the line II-II of FIG. 1, with FIG. 2a showing a configuration before the modular roof is fitted, FIG. 2b showing the configuration after the modular roof is put in position, and FIG. 2c showing the configuration after the modular roof has been firmly pressed in place;

FIG. 3a shows a section along the line III-III of FIG. 2c, in an enlarged view;

FIG. 3b shows the region of FIG. 3a in an alternative embodiment;

FIG. 3c shows the region of FIG. 3a in a further embodiment; and

FIG. 3d shows the region of FIG. 3a in a further embodiment.

### DETAILED DESCRIPTION OF THE INVENTION

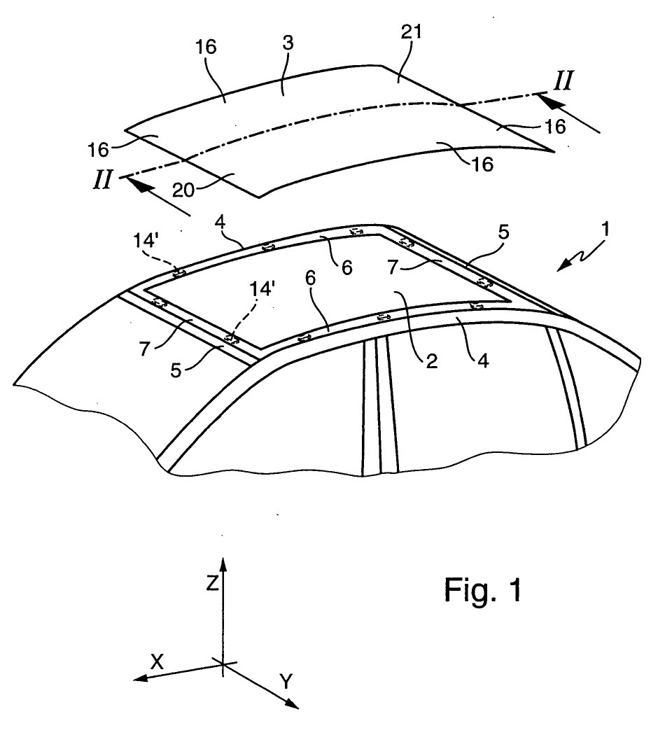

FIG. 1 shows a perspective schematic view of a vehicle body 1 with a roof opening 2 into which a modular roof 3 is to be fitted. The roof opening 2 is bounded in the transverse direction Y of the vehicle by side struts 4 and in the longitudinal direction X of the vehicle by a front and a rear transverse strut 5. The roof opening 2 is provided with flanges 6, 7 which encircle it on the edge side and in the region of which the modular roof 3 is connected to the vehicle body 1. In this case, the reference numbers 6 refer to the flanges which are adjacent to the side struts 4 while the reference numbers 7 refer to the flanges which are adjacent to the transverse struts 5.

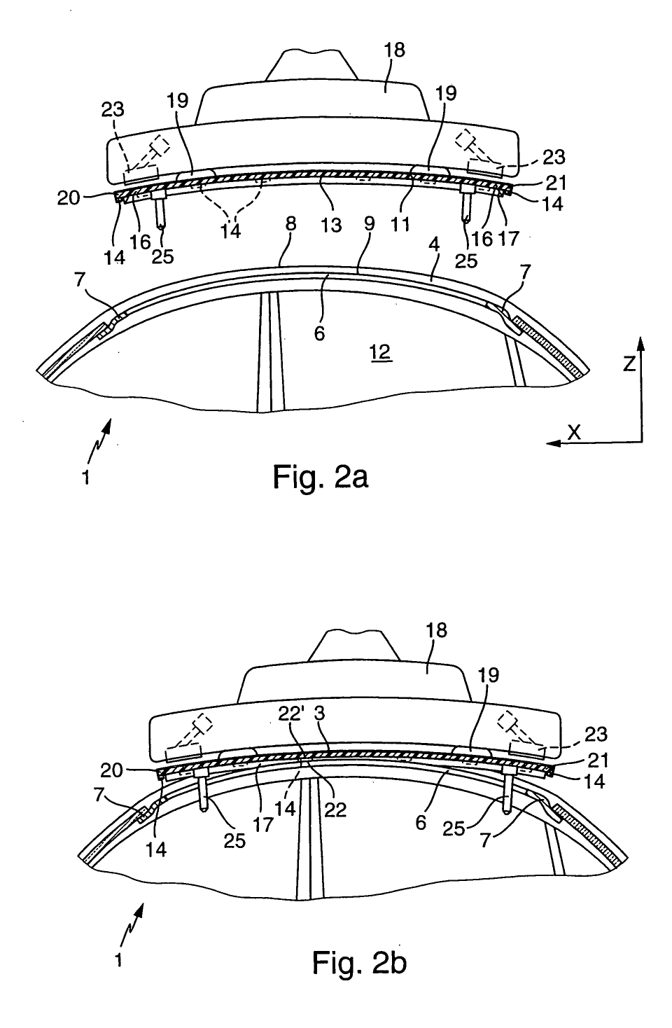

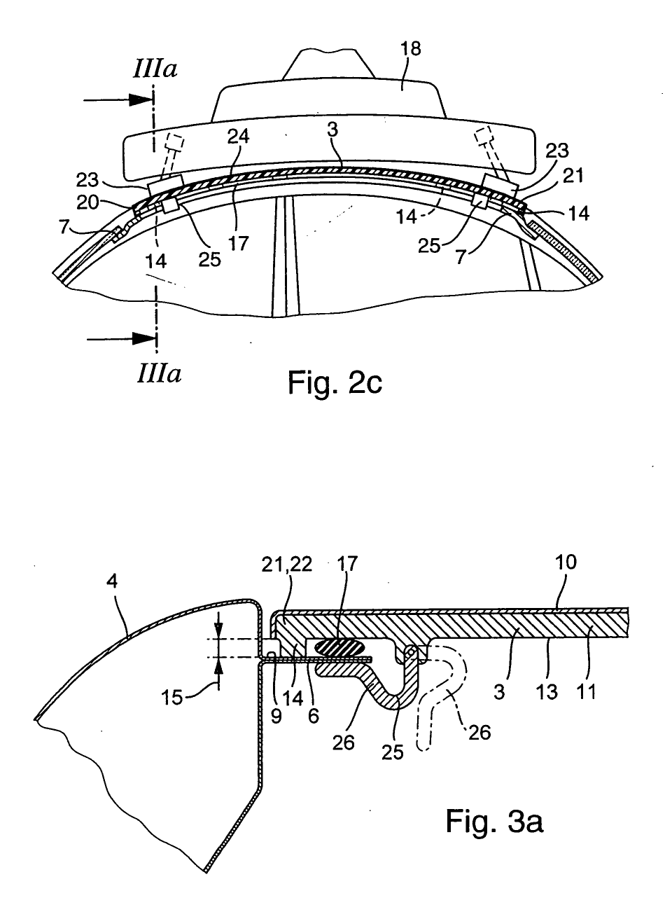

As can be seen clearly in particular from the sectional views of FIGS. 2a to 2c, the flanges 6 have a convexity in the longitudinal direction X of the vehicle; in the present case, “convexity” is to be understood as a convex curvature in the vertical (Z) direction. In general, the convexity of the flanges 6 corresponds to the convexity of the vertical contour 8 of the side struts 4, so that the upper sides 9 of the flanges 6 run essentially parallel to the vertical contour 8 of the side struts 4.

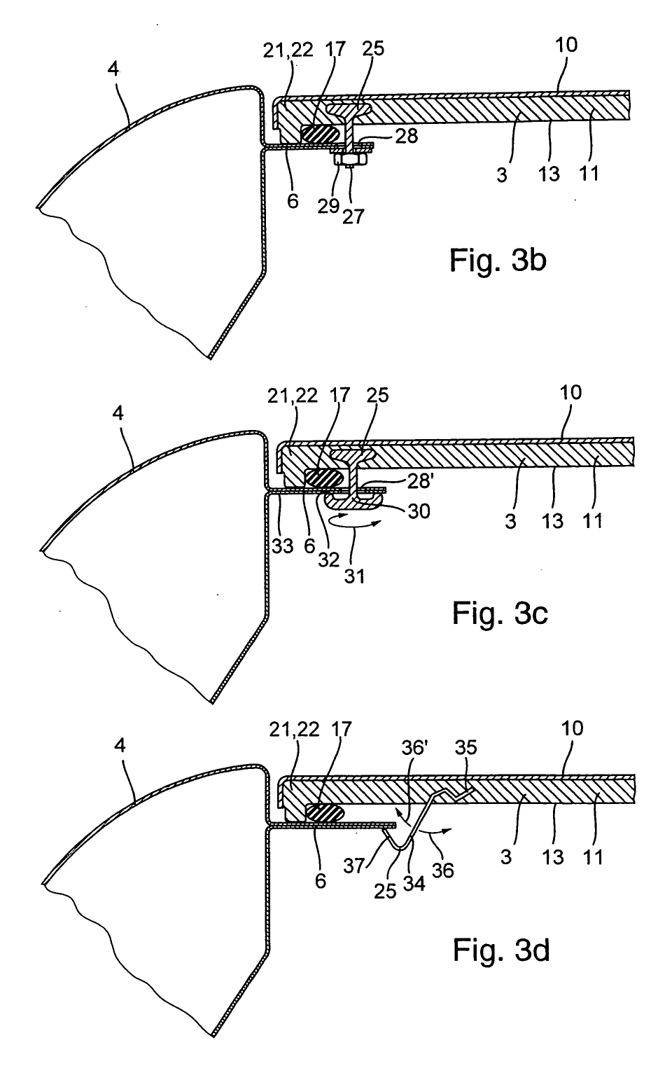

In the illustration of FIG. 1, the modular roof 3 is illustrated schematically as a fixed roof and, in the present exemplary embodiment, comprises a formed part 10 of steel or aluminum plate which has a molding compound 11 injected behind it in order to increase the stiffness. As an alternative, the modular roof 3 may also be a plastic part or an SMC part with plastic injected behind it. Furthermore, a glass roof, a sliding roof, a lamella roof etc. may also be inserted as the modular roof 3 into the body 1. On its inner surface 13 which faces the body interior 12, the modular roof 3 is provided on the edge side with stud-or rib-like spacers 14 (illustrated by dashed lines in FIGS. 2a to 2c). After the modular roof 3 is fitted into the body 1, these spacers 14 rest on the flanges 6, 7 and ensure that a certain minimum spacing 15 is guaranteed overall between the inner surface 13 of the modular roof 3 and the flanges 6, 7 (see FIG. 3a).

The sectional views of FIGS. 2a to 2c show selected snapshots of the fitting of the modular roof 3 into the vehicle body 1. In a process step (not illustrated in FIG. 2) which takes place upstream, an encircling adhesive bead 17 is first of all applied in edge regions 16 on the inner surface 13 of the modular roof 3. The modular roof 3 is then transferred to a robot-guided installation tool 18 or a handling device with the aid of which the modular roof 3 is inserted into the roof opening 2 of the vehicle body 1. FIG. 2a shows the modular roof 3 which is held in the installation tool 18 with the aid of suction caps 19, at a time before it is lowered into the roof opening 2.

As can be seen from FIG. 2a, the modular roof 3 has a convexity in the longitudinal direction X of the vehicle, the convexity of the modular roof 3 being smaller, according to the invention, than the convexity of the flange 6. The difference in the convexity of the flange 6 and of the modular roof 3 is illustrated in greatly exaggerated form in FIG. 2a; in reality, the difference between the two convexities is very small, with the result that a modular roof 3 which has been placed onto the flanges 6 gapes open in its front and/or rear end regions 20, 21 merely by a few millimeters in relation to the flanges 7 of the transverse struts 5. The dimensioning of the convexity of the modular roof 3 depends heavily on the manufacturing inaccuracies of the modular roof 3 and of the vehicle body 1 in the region of the roof opening 2: the convexity of the modular roof 3 has to be selected in such a manner that in every case the modular roof 3 provided for the installation of the roof has a smaller convexity than the body 1 into which this modular roof 3 is to be inserted. The convexity of the roof module 3 therefore has to be reproducibly smaller than the smallest acceptable convexity of the flanges 6 in the roof opening 2. This ensures that both sides of the modular roof 3, when it is lowered onto the roof opening 2 within the scope of the installation of the roof, rest only on a single point 22 in each case on the flanges 6. FIG. 2b shows the modular roof 3 which is laid onto the body 1 and in its central region 22′ rests on the flanges 6 of the roof opening 2 and—owing to its smaller convexity—has a gap in relation to the flanges 7 in its front and rear end regions 20, 21.

In a next process step, the front and rear end regions 20, 21 of the modular roof 3 are pressed down onto the flanges 7; for this purpose, the installation tool 18 is provided with hydraulically or pneumatically actuable pressure cushions 23 which act on the upper side 24 of the modular roof 3 in the end regions 20, 21 (see FIG. 2c). During the pressing onto the end regions 20, 21, the lateral edges 16 of the modular roof 3 are pressed progressively—starting from the contact points 22 which already rest on both sides and proceeding as far as the end regions 20, 21—onto the opposite flanges 6, 7 of the roof opening 2. In the process, the adhesive bead 17 is compressed—starting from the two contact points 22—in an encircling manner into the clearance between the modular roof 3 and flange 6, 7 of the roof opening 2, with the result that an encircling adhesive web is formed between the roof opening 2 and modular roof 3. The spacers 14 provided on the edge side of the modular roof 3 ensure that there is a minimum spacing 15 (corresponding to the height of the spacer 14) between the opposite bonding regions on the flanges 6, 7 and the inner surface 13 of the modular roof 3 and therefore that the adhesive is not squeezed out of the bonding region. The uniform spacing 15 in the bonding region means that there is overall an optimum quantity of adhesive encircling along the flanges 6, 7, which ensures that the bonding connection has high strength and good seal tightness. The spacers 14 are preferably situated closer to the modular roof edge 16 than the adhesive bead 17.

The modular roof 3 is now fixed in relation to the vehicle body 1 in the tensioned state which is produced with the aid of the pressure cushions 23. Use is made for this purpose of fixing elements 25 which are arranged on the inner surface 13 of the modular roof 3 in the front and rear end regions 20, 21. In the exemplary embodiment of FIGS. 2a to 2c, these fixing elements 25 are formed schematically by pivotable hooks 26. These hooks 26 are pivoted into the inner region of the modular roof 3 during the insertion of the modular roof 3 in order to avoid collisions of the hooks 26 with the flanges 6; after the front and rear end regions 20, 21 are pressed down, the hooks 26 are pivoted outward, so that they engage under the flanges 6 of the roof opening 2 and prevent the tensioned modular roof 3 from springing back. This is illustrated in the detailed view of FIG. 3a, in which the pivoting position of the hooks 26 in the final fitted position as indicated by solid lines and, during the insertion of the modular roof, by chain-dotted lines.

As an alternative or in addition to the above-described arrangement of the fixing elements 25 along the sides of the modular roof, the fixing elements 25 can also be arranged in the region of the rear or front edge 20, 21 of the modular roof 3 and can engage under the flange 7.

FIG. 3b shows an alternative exemplary embodiment of a fixing element 25: in this case, the fixing element is formed by a bolt 27 which is guided through a cutout 28 in the flange 6, 7 of the roof opening 2. The tensioned state of the modular roof 3, which is produced by the edge regions 20, 21 being pressed down, is fixed by nuts 29 which are screwed onto the bolts 27 protruding through the cutouts and are tightened. FIG. 3c shows a further exemplary embodiment of a fixing element 25 as a rotatable hook 30 which penetrates into a correspondingly shaped cutout 28′ in the flange 6, 7 when the modular roof 3 is lowered and, after the end regions 20, 21 are pressed down, is rotated in accordance with the arrow 31 into a position such that the hook upper side 32 bears on the lower side 33 of the flange 6, 7 and therefore prevents the tensioned modular roof 3 from springing back. Furthermore, the fixing elements 25 can be formed, for example, by means of pins which—protruding from the inner surface 13 of the modular roof 3—are guided through cutouts 28 in the flanges and, after the modular roof 3 is clamped, are fixed in relation to the flange lower sides 33 with the aid of spring washers.

A further embodiment of the fixing element 25 is illustrated in FIG. 3d: in this case, the fixing element 25 is formed by a spring hook 34 which is connected to the modular roof 3 and latches automatically to the flange 6, 7 during the joining process. In the example of FIG. 3d, that end 35 of the spring hook 34 which is connected to the modular roof 3 is embedded in the molding compound 11 of the modular roof 3, but may also be connected to the modular roof 3 in any other desired manner. When the modular roof 3 is inserted into the roof opening 2 of the body 1, the free end 37 of the spring hook 34 is initially forced back (arrow 36) by the action of the flange 6, 7 and, when the modular roof 3 is lowered further, snaps into the latching position (arrow 36′) which is shown in FIG. 3d and in which the modular roof is then fixed in relation to the flange 6, 7 by the spring action of the spring hook 34.

As an alternative or in addition to the spacers 14 (shown in FIGS. 2a to 2c) on that inner surface 13 of the modular roof 3 which faces the flanges 6, 7, upwardly protruding spacers 14′ may also be provided on the upper side 9 of the flanges 6, 7; this is indicated in FIG. 1 by dashed lines. The spacers 14′ may be placed into the flanges 6, 7, for example, during the deep-drawing process or may be produced in a separate stamping process.

Although the above description referred to fixing elements 25 which are fastened to the modular roof 3 and, in the fitted position, penetrate or engage under the flanges 6, 7 of the roof opening 2, the fixing elements can also be provided on the vehicle body 1, in particular in the region of the flanges 6, 7 of the roof opening 2, and, in the assembled position, can engage in the modular roof.

1-7. (canceled)

8. A modular roof for a motor vehicle, adapted to fit into a roof opening provided in a motor vehicle body using a bonding process in the course of the assembly of the vehicle, comprising:
edge-side bonding regions in which the modular roof, in a fitted position, is adapted to overlap with at least one flange of the roof opening of the motor vehicle body, both the flange of the roof opening, in a region of side struts, and the modular roof having a convexity in a longitudinal direction of the vehicle, and
fixing elements provided for clamping front and rear end regions of the modular roof in relation to the roof opening,
wherein the convexity of the modular roof is smaller in the longitudinal direction of the vehicle than the convexity of the flange of the roof opening in the region of the side struts.

9. The modular roof as claimed in claim 8, wherein the fixing elements are designed as hooks which engage under the flange of the roof opening in the fitted position of the modular roof.

10. The modular roof as claimed in claim 8, wherein the fixing elements are designed as hooks, bolts or pins which, in the fitted position of the modular roof, protrude through cutouts of the roof opening.

11. The modular roof as claimed in claim 8, wherein the modular roof is provided in the edge-side bonding regions with spacers which protrude from the inner surface of the modular roof in the direction of the at least one flange of the roof opening.

12. The modular roof as claimed in claim 8, wherein the modular roof is a sheet-metal formed part with a molding compound injected behind it.

13. The modular roof as claimed in claim 8, wherein the modular roof is a plastic part with a molding compound injected behind it.

14. The modular roof as claimed in claim 9, wherein the modular roof is provided in the edge-side bonding regions with spacers which protrude from the inner surface of the modular roof in the direction of the at least one flange of the roof opening.

15. The modular roof as claimed in claim 10, wherein the modular roof is provided in the edge-side bonding regions with spacers which protrude from the inner surface of the modular roof in the direction of the at least one flange of the roof opening.

16. The modular roof as claimed in claim 9, wherein the modular roof is a sheet-metal formed part with a molding compound injected behind it.

17. The modular roof as claimed in claim 10, wherein the modular roof is a sheet-metal formed part with a molding compound injected behind it.

18. The modular roof as claimed in claim 14, wherein the modular roof is a sheet-metal formed part with a molding compound injected behind it.

19. The modular roof as claimed in claim 15, wherein the modular roof is a sheet-metal formed part with a molding compound injected behind it.

20. The modular roof as claimed in claim 9, wherein the modular roof is a plastic part with a molding compound injected behind it.

21. The modular roof as claimed in claim 10, wherein the modular roof is a plastic part with a molding compound injected behind it.

22. The modular roof as claimed in claim 14, wherein the modular roof is a plastic part with a molding compound injected behind it.

23. The modular roof as claimed in claim 15, wherein the modular roof is a plastic part with a molding compound injected behind it.

24. A method for installing a modular roof into a motor vehicle body with the aid of a bonding process, the modular roof having an edge-side bonding region in which the modular roof, in a fitted position, is adapted to overlap with at least one flange in the roof opening of the motor vehicle body, the flange of the roof opening having a convexity in a longitudinal direction of the vehicle in a region of side struts, the modular roof having a convexity in the longitudinal direction of the vehicle which is smaller than the convexity of the flange in the region of the side struts, the modular roof being provided with fixing elements for clamping front and rear end regions of the modular roof in relation to the roof opening, comprising:
placing the modular roof, which is provided with an adhesive bead, in the fitted position onto the flange of the roof opening, and
clamping the modular roof by pressing down in the front and rear end regions onto the flanges of the roof opening, and fixing the modular roof in a clamped position in relation to the vehicle body with the aid of the fixing elements.
